(19) United States
(12) Patent Application Publication
(10) Pub. No.: US 2018/0177221 A1
(43) Pub. Date: Jun. 28, 2018

(54) MICROSTRUCTURED FOOD ITEM

(71) Applicant: Prin2Taste GmbH, Freising (DE)

(72) Inventor: Wolfgang Siebold, Freising (DE)

(73) Assignee: PRINT2TASTE GMBH, Freising (DE)

(21) Appl. No.: 15/737,691

(22) PCT Filed: Jun. 24, 2016
(86) PCT No.: PCT/EP2016/064698

§ 371 Date: Dec. 18, 2017

(30) Foreign Application Priority Data
Jun. 25, 2015 (DE) 10 2015 008 247.7

(51) Int. Cl. A23P 20/20; B33Y 10/00; B33Y 30/00; B33Y 80/00

(52) U.S. Cl. CPC A23P 20/20; B33Y 10/00; A23P 2020/253; B33Y 80/00; B33Y 30/00

(57) ABSTRACT

The present invention relates to a method for three-dimensionally structuring a food product as well as to a device for carrying out the method. The invention further relates to a microstructured food product.

The present invention relates to a method for three-dimensionally structuring a food product, a device for carrying out such a method as well as a microstructured food product.

In the past few years, so-called 3D printers have been increasingly used in food product technology. Usually, a single food product component in a flowable condition is brought into the desired three-dimensional shape and subsequently hardened. Such methods have been used so far, for example, in the production of shapes made of chocolate or sugar as well as the generation of new shapes of pasta. In some cases, it has also been tried to combine different food product components with each other. WO 2011/117012 A1, for example, describes the selective application of specific dietary supplements onto food products. In particular, WO 2011/117012 A1 describes the application of different food product components in layers, which, however, only permits the production of a layered food product. Furthermore, a system for the production of a freely shaped three-dimensional food product is known from US 2013/0034633 A1. On the one hand, US 2013/0034633 A1 describes the production of layered food products which may consist, for example, of alternating layers of sugar and cacao. On the other hand, a method is described by means of which specific properties of the thus generated food product can be varied also within the layers. To this end, however, first a respective layer of the basic food product has to be applied which can then be selectively varied in a purposeful way by respective additives of, for example, flavoring substances and colorants, which considerably restricts the possibilities of the variation of food product components.

EP 2 937 206 A1 describes a method for producing a food product on the basis of chocolate, in which the chocolate must harden after the metering operation in order to serve as a crystallization initiator for the next layer and in which the solid chocolate then forms a complete inner and outer 3D structure into which then liquid or gaseous substances can be incorporated into internal chambers having solid walls. This method turns out to be disadvantageous in that there are necessarily solid structures also within the food product produced with the described method. Additionally, the absolutely necessary solidification of the uppermost layer prior to the application of the subsequent layer prevents the optimal melting of the individual layers into a homogenous final 3D product.

WO 2010/151202 A1 describes a method for printing food products in which small drops of a liquid food product and a liquid binder, which preferably consists of the gelling agent alginate and immediately solidifies after the printing operation, are used. The ratio of the amount of food product and binder determines in this case the hardness of the food product. What is described here is only a gelled final product in which the binder is homogeneously distributed in the entire food product.

US 2013/0034633 A1 describes a method of production for a three-dimensional food product object in which solidification locally occurs in a powder layer by a locally limited application of liquid drops due to the bonding of the liquid and the powder. A 3D food product structure is formed by the application of further powder layers and structures of liquid drops after the removal of the non-solidified powder regions. The very complex manufacturing method permits only to produce hard crystalline structures without the possibility of introducing gaseous or liquid microstructures in the final product.

Therefore, an object to be achieved with the present invention is to provide an improved method for three-dimensionally structuring a food product as well as a device appropriate for this method. Furthermore, an object to be achieved with the present invention is to provide an improved food product. These objects are achieved by the method, the device and the microstructured food product according to the independent claims. Preferred embodiments are described, i.a., in the dependent claims.

Accordingly, the present invention, i.a., relates to a method for three-dimensionally structuring a food product. A first food product component is introduced into a plurality of first unoccupied volume elements of the food product to be structured, and a second food product component is introduced into a plurality of second unoccupied volume elements of the food product to be structured, wherein the second food product component differs from the first food product component and wherein the first and second volume elements are disjunctive. What is meant by an unoccupied volume element is a volume element in which there is no food product component prior to the introduction of the respective food product component. Typically, an unoccupied volume element contains exclusively air or a protective gas before the introduction of the respective food product. The first and second volume elements should be disjunctive, which means that each volume element is occupied either by the first food product component or the second food product component (or one or more further food product components). It is, of course, possible that the first and second food product components at least partially intermix in the area of the interface between a first and a second volume element after their introduction. According to the invention, however, individual unoccupied volume elements should be successively occupied or filled with different food product components without, for example, one food product component being injected into the other food product component. In other words, the food product to be structured or generated is made up of the different food product components volume element by volume element.

The individual volume elements can assume any desired shape. Preferably, the first and second volume elements are composed of voxels having a constant size. Such a voxel can likewise have any desired shape and size. Most preferably, however, the individual voxels are cuboid-like, i.e. the voxels have a shape similar to cuboids with rounded corners and/or edges. Furthermore, an individual voxel preferably has a volume of less than 30 mm³, more preferably of less than 20 mm³, even more preferably of less than 10 mm³ and most preferably of less than 5 mm³.

The present invention certainly is not restricted to food products only consisting of two different food product components. In fact, one or more further food product components can optionally be introduced into a plurality of further unoccupied volume elements of the food product to be structured, wherein the one or more further food product components differ from both the first and the second food product component. The fact that they are disjunctive just as the first and second volume elements preferably also applies to these further volume elements.

In order to maintain the shape of the food product to be structured, one or more of the food product components are solidified and/or stabilized. The solidification and/or stabilization can take place in one step or comprise two or more solidification and/or stabilization steps. As apparent from the subsequent preferred embodiments, the solidification and/or stabilization of a food product component can generally comprise any method step that permits to prevent the flowability of at least one of the food product components to such an extent that the shape of the structured food product is essentially maintained. This can be realized, for example, in that bonds are formed within a food product component and/or in that the molecular structure and/or its arrangement is varied. A gel can be formed, for example, by means of temperature influences. However, the gel formation can also be effected by a change in the pH value or by specific enzymes. The food product component may also be a food product component that is firstly present in a stable form but is shear-liquefied and/or shear-thinned during its introduction, for example when leaving a nozzle, and automatically reassumes its stable form after the introduction.

A first step of stably shaping and thus solidifying can be followed by a second step in which a further solidification and/or increase in stability is effected. This further solidification can take place, for example, by the described gel formation and/or water outlet and thus drying due to a heating step. In other words, a drying operation can be provided as a second or further solidification step. However, other additional steps for further solidification and/or stabilization are also possible.

Preferably, the step of solidifying and/or stabilizing is to be understood in the context of the present invention such that after the stabilization the viscosity of the component to be stabilized is higher than before. Preferably, the stabilized and/or solidified food product component has a viscosity of at least 5000 mPa s, more preferably of at least 7000 mPa s and most preferably of at least 8000 mPa s.

It is emphasized in this context that the present invention does not require a specific chronological order of the individual method steps. As apparent from the above statements, the solidification or stabilization of one or more food product components can take place after the introduction of the respective food product components or essentially at the same time therewith. This depends primarily on the technique of solidifying and/or stabilizing. If the influence of temperature, pH value and/or enzymes is necessary for the solidification, the solidification will usually take place with a delay after the introduction of the food product component into the respective volume element. However, in the case of shear-thinning, the stabilization will usually take place directly after the escape from the nozzle so that the stabilization of the food product component already starts while the food product component is introduced into an unoccupied volume element. If the step of solidifying and/or stabilizing comprises an active step such as, for example, heating and/or cooling one or more food product components, it is basically possible that firstly some volume elements are occupied by food product components and hardened before further volume elements are occupied and hardened. The food product to be structured can be introduced and solidified, for example, in layers. Alternatively, it is possible that firstly all volume elements to be occupied are occupied by food product components and subsequently the entire food product is solidified and/or stabilized. The preferred procedure heavily depends on the rheological properties of the individual food product components: If the food product components are very liquid and/or flowable, it is preferred that they are hardened in layers before the next layer of food product components is applied. If the food product components are rather gel-like structures, it may be advantageous to perform the final solidification and/or stabilization only after the entire food product has been made up of the components.

The method according to the present invention permits to make up a food product of different food product components voxel by voxel, wherein it is not only possible to control exactly how the food product to be structured is made up of the individual food product components on a quantity basis but also to influence selectively at which positions in the finished food product specific food product components are present in which concentration. Thus, it is possible, for example, to incorporate specific food product components, such as, e.g., salt or sugar, which should be contained in as small doses as possible for health considerations, into the food product exclusively or to a great extent near the surface. Since many food products are often not completely chewed, the taste sensation is primarily dominated by ingredients arranged in the vicinity of the surface. The method according to the present invention permits to adjust any concentration gradients wherein it can also be controlled how large, for example, the salt-containing volume elements as well as the remaining volume elements are. To this end, it is advantageous that at least part of the second volume elements are completely surrounded by first and/or one or more further food product components. Accordingly, the invention is not directed to a merely layered food product but to a structure in which, at least in some first volume elements, the second food product component is completely surrounded by the first and/or one or more further food product components. This permits not only an optimal dosage of the individual food product components but also their distribution as homogenous as possible or their selectively inhomogeneous distribution.

Preferably, at least 50%, more preferably at least 80%, even more preferably at least 90% of the second volume elements and most preferably all second volume elements are completely surrounded or enclosed by the first and/or one or more further food product components. If all second volume elements are completely surrounded by other food product components so that the second food product component does not get into contact with the surface of the food product to be structured, it is also possible to create specific, for example, multi-phase food products with the method of the present invention.

Thus, it is possible, for example, to incorporate liquid drops (which may comprise, for example, oil or water) selectively and in a controlled size into one or more other food product components which are solid or gel-like after the solidifying and/or stabilizing step. These liquid drops can comprise, for example, oils or flavoring substances and be freely configured in a completely flexible way as regards their size and positioning. This is not possible with methods available so far, such as homogenization. Advantageously, these food products can lead to an increased flavor release during crushing operations such as the chewing process if, for example, the flavoring substances have been introduced in the vicinity of the surface of the food product.

In a similar manner, a foam can be created if one of the food product components is gaseous. In this case, the introduction of a food product component into an unoccupied volume element can also include the non-introduction if the unoccupied volume element comprises air or a protective gas that corresponds to the gas in the foam. Advantageously, here too, the position and size of the unoccupied volume element can be freely selected, which advantageously may lead to an increased flavor release due to the accumulation of the flavoring substances from the surrounding voxels in the unoccupied volume elements.

In the method according to the invention, the stability of the food product is achieved or ensured in that selectively specific volume elements and/or specific food product components are solidified and/or stabilized. These stabilizing volume elements can be present in an ordered or unordered way and distributed in the food product in a relatively homogenous way or be provided only at defined positions that are decisive for the stability. For example, only a solid or solidified or stabilized outer and/or inner supporting structure that guarantees stability for a specific 3D shape is necessary. It is thereby possible with the method according to the present invention to generate within this structure also structures that are completely liquid/liquid (e.g. emulsion) or liquid/gaseous (e.g. foam) without the three-dimensional outer and/or inner structure being destroyed thereby and that do not at all or only in a subsequent treatment step (e.g., heating during the course of a baking or roasting process) continue to partially or completely solidify.

Thus, for example, first and second volume elements or voxels can be occupied by different liquids, or first volume elements can be occupied by a liquid and second volume elements by a gas, each of which does not substantially or sufficiently contribute to the stability of the food product. In such an event, the stability can then be ensured in that third and/or further volume elements are solidified and/or stabilized. To this end, other food product components that are hardened by a solidification and/or stabilization step can be used in the third volume elements, whereas the first and the second volume elements continue to be liquid or gaseous after this step. Alternatively, the third volume elements could also contain the first and/or the second food product component which, however, is here selectively solidified. This could take place, for example, on the surface of the food product, e.g., by a baking step, wherein, for example, the temperature necessary for the solidification is not achieved at the first and second volume elements. Thus, the third volume elements preferably form a stabilizing skin or shell which preferably completely surrounds or covers the food product. Depending on the shape of the food product, however, the skin can also be only provided partially on the surface. The stabilizing skin or shell could be present, for example, in the shape of a cup so that the upper surface of the food product is formed by liquid and/or gaseous volume elements.

Alternatively or additionally to a stabilizing skin or shell, the third volume elements may also stabilize the food product inside in that, for example, a netlike or honeycomb-like structure is formed. To this end, the third volume elements can form stabilizing areas inside the food product which preferably completely surround individual sectors of the food product. The third volume elements may form, for example, vertical and horizontal stabilizing walls which intersect in a netlike way. Other ordered or unordered structures, of course, are conceivable as well. However, it is preferred that sectors that contain both first and second volume elements are surrounded by third volume elements so that, for example, sectors with an emulsion of first and second liquid food product components are surrounded and/or enclosed by a shell or skin of the third, stabilized food product component each. Analogously, for example, sectors with a foam of first gaseous and second liquid food product components could be enclosed and/or surrounded by a shell or skin of the third, stabilized food product component each.

According to the invention, it is possible that in the whole food product, between voxels responsible for the solidity, there may also be voxels that do not solidify but would be intermixable with the former (i.e., there is no phase boundary in this case). What is meant according to the invention by a food product component that does not solidify is a food product component whose viscosity, even after solidification and/or stabilization, is still lower than 5000 mPa s, preferably lower than 4000 mPa s and most preferably lower than 3000 mPa s. According to the invention, the ingredients in the non-solidified voxels can preferably exhibit either a higher bioavailability, for example, when proteins, lipids, carbohydrates, dietary fibers, vitamins or mineral nutrients as well as secondary plant ingredients are comprised therein. Furthermore, due to their higher volatility, flavoring substances in the non-solidified voxels may lead to an increased perception of aroma during crushing operations such as, for example, the chewing process. Upon their release during crushing operations such as, for example, the chewing process, gustatory substances such as, for example, sugar or also salt can lead to an increased flavor release of sweet or salty tastes in the non-solidified voxels and thus to an increased sense of taste. It is thus advantageously possible to reduce the salt or sugar content in such food products while the sense of taste is the same as with a conventional food product.

According to the invention it is further possible that in the whole food product, between voxels responsible for the solidity, there may additionally also be voxels that are crystalline or powdery. In other words, non-solidifying food product components, which continue to be relatively liquid or gaseous even after the solidification (see above), and/or food product components which are solid from the outset and likewise do not contribute anything to the stabilization can also be contained in addition to solidifying food product components ensuring the stability of the food product to be structured. Voxels of salt or sugar crystals, for example, can be surrounded by solidified voxels. Advantageously, these crystalline voxels of sugar or salt crystals can lead to an increased perception of taste of the sweet or salty taste impression. Additionally, a crusty or crispy taste impression can advantageously be generated with such crystalline or powdery voxels.

According to the invention, it is also possible that there are more than two different food product components as voxels in the food product so that the food product is built of a mixture of voxels of more than two food product components. Voxels of light-sensitive and heat-sensitive ingredients, for example, can be inside the food product whereas ingredients resulting in a sweet or salty taste experience are close to the surface.

It is further preferred that at least 50%, more preferably at least 80%, even more preferably at least 90% of the first volume elements and most preferably all first volume elements are completely surrounded by the second and/or one or more further food product components.

Preferably, at least part of the second volume elements each have a volume that is smaller than 30 mm³, preferably smaller than 20 mm³, more preferably smaller than 10 mm³ and most preferably smaller than 5 mm³. The part of the second volume elements is preferably at least 50%, more preferably at least 80%, even more preferably at least 90% of the second volume elements and most preferably all second volume elements. The larger the individual volume elements, the simpler, faster and less expensive the production of the food product to be structured. Particularly small volume elements, however, permit particularly favorable features with respect to the texture and the perceived homogeneity of the produced food product.

The first and/or the second food product component (as well as all further food product components) can be generally liquid, gaseous, gel-like or pasty prior to the solidification and/or stabilization. However, while being introduced, the first and/or second food product component should preferably be flowable to such an extent that the volume elements to be occupied are essentially completely filled with the respective food product component. Since the food product components are optionally only sufficiently shear-thinned when leaving a respective metering nozzle, this is no limitation as regards the state of matter of the food product components prior to their introduction. However, the first and/or second food product component is preferably liquid, gaseous, gel-like, pasty or solid after the solidification and/or stabilization, wherein at least one of the food product components is preferably gel-like, pasty or solid after the solidification and/or stabilization in order to sufficiently stabilize the entire food product. Preferably, the first food product component is liquid, gel-like or pasty before the solidification and/or stabilization and gel-like, pasty or solid after the solidification and/or stabilization, wherein the first food product component preferably has a higher viscosity after the solidification and/or stabilization than before the solidification and/or stabilization. To this end, the first food product component may preferably contain a binder. Even if the second food product component may also contain a binder, it is not necessary since the second food product component remains liquid or gaseous after the solidification and/or stabilization in a particularly preferred embodiment of the method according to the invention. Accordingly, the first and second food product components are preferably present in different phases after the solidification and/or stabilization.

As already initially explained, the solidification and/or stabilization can be based on different techniques and may comprise different method steps, which can be performed essentially simultaneously with the introduction of the food product component or after its introduction.

According to a first preferred variant, the solidification and/or stabilization of one of the food product components comprises heating or cooling the respective food product components. The food product components are heated preferably by at least 5 K, more preferably by at least 15 K and most preferably by at least 30 K. The food product components are preferably heated to at least 30° C., more preferably to at least 35° C. and most preferably to at least 40° C. Additionally or alternatively, the solidification and/or stabilization can comprise cooling the food product components by at least 5 K, more preferably by at least 20 K and most preferably by at least 40 K. The food product components are preferably cooled to at most 60° C., more preferably to at most 40° C. and most preferably to at most 20° C.

According to a second preferred variant, the solidification and/or stabilization is at least partially due to shear-liquefaction or shear-thinning of at least one of the food product components and subsequent solidification. This aspect is based on the fact that one or more food product components have shear-thinning properties and initially, i.e. before their introduction, are gel-like, pasty or solid. When these food product components are pressed through a metering nozzle at an appropriate pressure, they are liquefied and/or thinned due to the shear strain occurring during this operation so that they can be easily introduced into the volume elements to be occupied. As soon as the food product component liquefied or thinned in this manner leaves the metering nozzle, a solidification starts again which results in that the respective food product component is solidified and/or stabilized shortly after its introduction into the respective volume elements. To this end, an appropriate texturing agent such as, for example, xanthan gum can be added to one or more of the food product components. This technique is particularly preferred because of the extremely rapid solidification. However, it may be necessary to further solidify and/or stabilize the structured food product by means of further process steps such as, for example, forming further gel structures.

According to a further preferred variant, the solidification and/or stabilization can also be at least partially due to a change in the pH value of at least one food product component, wherein the change in the pH value can be induced, for example, by microorganisms and/or acidifiers which can be added to one of the food product components.

Alternatively or additionally, the solidification and/or stabilization can be at least partially due to crosslinking of proteins in at least one of the food product components, wherein this crosslinking can be induced, for example, by enzymes which can be added to one or more of the food product components. Alternatively, this crosslinking may also be achieved by locally heating the printed object already during or after the termination of the printing operation by heat supply, preferably by means of laser, microwave or IR radiation or other heat radiation.

The method according to the invention is preferably performed automatically. To this end, the first food product component is dispensed from a first metering outlet and the second food product component is dispensed from a second metering outlet, wherein each of the first and second metering outlets can be positioned and/or moved or displaced along at least two degrees of freedom with the aid of a positioning device. The device for carrying out the method according to the present invention further comprises a control device adapted to control the positioning device as well as the operation of dispensing the first and second food product components from the first and second metering outlets.

The device for carrying out the above described method preferably further comprises a first receptacle and a second receptacle containing the first food product component and the second food product component, respectively. Of course, further receptacles for further food product components and/or further metering outlets for dispensing further food product components may be provided.

The present invention, of course, is restricted neither to two metering outlets nor to two receptacles. It is also possible that a plurality of metering outlets and/or a plurality of receptacles are provided for processing a plurality of food product components (e.g. for structuring more complex food products of three or more food product components and/or for structuring different food products containing different food product components). It is not necessary that the individual receptacles contain different food product components each. In fact, it is possible that a plurality of receptacles are provided which contain the same food product component. This may be advantageous, for example, if the device is only adapted to accommodate receptacles having a standard size and if the need for one food product component is considerably greater than the need for another food product component. Since preferably one metering outlet is assigned to each of the food product receptacles, it is accordingly also possible that a plurality of metering outlets is provided for one and the same food product.

Preferably, the positioning device is further adapted to position and/or move or displace the first and second metering outlets (and corresponding further metering outlets) along a third degree of freedom. In this event, the food product to be structured is created on a static substrate or surface wherein positioning the first and second metering outlets along all three spatial directions is necessary for three-dimensionally structuring a food product. Alternatively, one degree of freedom can also be provided in that the substrate can be moved in one direction, for example, on a conveyor belt or a rotary table. In view of higher accuracy and easier control, however, it is preferred that three degrees of freedom are provided via the positioning device.

The first receptacle and the first metering outlet are preferably formed by a first metering container which contains the first metering outlet, for example, in the form of a metering nozzle. This is analogously true for the second receptacle and the second metering outlet. The first and second food product components (as well as potential further food product components) are preferably dispensed by means of first and second metering devices which are adapted to dispense the first and second food product components in controlled volumes from the first and second metering outlets. To this end, for example, pressure can be selectively built up or generated on the receptacle and/or in the receptacle for the respective food product component so that the food product component escapes from the metering outlet in controlled volumes and most preferably at a controlled flow rate. The pressure can be varied, for example, in time in that, for example, a plunger is moved in a controlled way in a cylinder by means of a step motor. Alternatively, pressure can also be constantly applied to the food product component in the respective receptacle and the operation of dispensing the food product component in controlled volumes can be regulated and/or controlled by opening and closing respective valves.

Preferably, the first and/or the second metering device is adapted to dispense a volume of less than 30 mm³, more preferably of less than 20 mm³, even more preferably of less than 10 mm³ and most preferably of less than 5 mm³ from the first and/or the second metering outlet. This can be achieved in particular in that the metering outlet has corresponding dimensions and in that the metering device can be controlled in a correspondingly precise manner, for example, by the use of step motors, pumps and/or valves. If a step motor is used, the food product component can be exactly metered, for example, by compressing a container or a syringe by means of a plunger moved by the step motor. If a pump is used, the pump can build up pressure, for example, by transporting the food product component in a container comprising a valve, wherein upon opening said valve the pressure causes a drop of the food product component to be placed in an exact dose at a specific position in the object to be printed.

The control device or a respective storage element contains information preferably in the form of a file with respect to the food product to be structured in view of its shape, its food product components and their spatial distribution. This information can be input by a user, transmitted by means of respective data connections or read in, for example, via a bar code. Then, the control device successively moves the respective metering outlets in a precisely defined sequence of individual steps with the aid of the positioning device to or near the first and second unoccupied volume elements and activates the respective metering device for a predetermined time in order to control the operation of dispensing the respective food product component from the respective metering outlet such that it is introduced into the respective unoccupied volume element. The food product components are preferably introduced in layers, wherein a substrate or surface on which the food product is created is taken as a basis and the food product is generated in layers which are parallel therewith. Within one layer, firstly all first volume elements may be filled with a first food product component and subsequently all second volume elements may be filled with the second food product component. Alternatively, however, first and second volume elements may also be alternatingly filled with the first and second food product components.

Subsequently or at the same time one or more food product components are solidified and/or stabilized. To this end, the metering device and/or the container for the food product component can comprise a heating and/or cooling device that can induce and/or accelerate the solidification and/or stabilization. The heating or cooling operation can take place, for example, by means of direct cold or heat transfer onto the container itself or onto the food product via a heated or cooled airflow or via a heated or cooled printing substrate.

The present invention further relates to a microstructured food product that consists at a plurality of first volume elements of a first food product component, that consists at a plurality of second volume elements of a second food product component and that optionally consists at a plurality of further volume elements of one or more further food product components. The second food product component differs from the first food product component, and the one or more further food product components likewise differ from the first and second food product components. The first and second volume elements (and optionally the plurality of further volume elements) are disjunctive and at least part of the second volume elements are completely surrounded or enclosed by the first and/or one or more further food product components. This part comprises preferably at least 50% of the second volume elements, more preferably at least 80% of the second volume elements, even more preferably at least 90% of the second volume elements and most preferably all second volume elements.

It is further preferred that at least part of the first volume elements are completely surrounded by second and/or one or more further food product components. This first part of the volume elements likewise comprises preferably at least 50%, more preferably at least 80%, even more preferably at least 90% of the first volume elements and most preferably all first volume elements.

Preferably, the respective volume of at least part of the second volume elements is smaller than 30 mm³, preferably smaller than 20 mm³, more preferably smaller than 10 mm³ and most preferably smaller than 5 mm³. This part of the second volume elements comprises preferably at least 50%, more preferably at least 80%, even more preferably at least 90% of the second volume elements and most preferably all second volume elements.

Preferably, the first and/or second food product component is liquid, gaseous, gel-like, pasty or solid. Most preferably, the first and second food product components are present in different phases. To this end, it is preferred that the first food product component comprises a binder, wherein the second food product component most preferably comprises no binder.

The subject-matter according to the present invention (partly only in the case of preferred embodiments) implies various technical advantages over the prior art. In contrast to the prior art described so far, the method according to the present invention permits to generate structures of food product components immiscible with each other (such as, for example, oil or gas as well as structurally stable liquid phases), wherein said structures are precisely defined (as regards, for example, particle size as well as particle distribution and position), without complicated previous intermixture, said precisely defined structures comprising, for example, advantages in the mouthfeel or bioavailability of the ingredients comprised therein.

Additionally, the method according to the present invention permits to achieve an increased release of flavor or generally an increased release of volatile substances, on the one hand, in that they are preferably placed at the surface of the food product, on the other hand, in that they are not uniformly distributed in a release-delaying food product matrix of, for example, proteins or carbohydrates or dietary fibers, but are placed separately from these ingredients in high concentrations in small sectors. Furthermore, it is possible with the method according to the present invention to place heat-sensitive or oxygen-sensitive ingredients such as, for example, health-promoting microorganisms or vitamins or secondary plant ingredients such as, for example, polyphenols, phytosterols or flavanols in the center of the food product and thereby protect them better against the destructive effect of heat or oxygen.

The present invention is further directed to the following aspects:
1. A method for three-dimensionally structuring a food product comprising the steps of:
   (a) introducing a first food product component into a plurality of first unoccupied volume elements of the food product to be structured;
   (b) introducing a second food product component into a plurality of second unoccupied volume elements of the food product to be structured, wherein the second food product component differs from the first food product component, wherein the first and second volume elements are disjunctive;
   (c) optionally introducing one or more further food product components into a plurality of further unoccupied volume elements of the food product to be structured, wherein the one or more further food product components differ from the first and second food product components; and
   (d) solidifying and/or stabilizing at least part of the volume elements occupied by one or more of the food product components;
   wherein at least part of the second volume elements are completely surrounded by the first and/or one or more further food product components.
2. The method according to aspect 1, wherein at least 50%, preferably at least 90% of the second volume elements are completely surrounded by the first and/or one or more further food product components.
3. The method according to aspect 1 or 2, wherein at least part of the first volume elements, preferably at least 50%, more preferably at least 90%, are completely surrounded by the second and/or one or more further food product components.
4. The method according to any one of the preceding aspects, wherein at least part of the second volume elements, preferably at least 50%, are smaller than 30 mm³, preferably smaller than 20 mm³, more preferably smaller than 10 mm³ and most preferably smaller than 5 mm³.
5. The method according to any one of the preceding aspects, wherein the first and/or second food product component is liquid, gaseous, gel-like or pasty prior to the solidification and/or stabilization.
6. The method according to any one of the preceding aspects, wherein the first and/or second food product component is liquid, gaseous, gel-like, pasty or solid after the solidification and/or stabilization.
7. The method according to any one of the preceding aspects, wherein the first food product component is liquid, gel-like or pasty prior to the solidification and/or stabilization and gel-like. pasty or solid after the solidification and/or stabilization.
8. The method according to aspect 7, wherein the first food product component exhibits a higher viscosity after the solidification and/or stabilization than before the solidification and/or stabilization.
9. The method according to aspect 7 or 8, wherein the first food product component comprises a binder.
10. The method according to aspect 7, 8 or 9, wherein the second food product component comprises no binder.
11. The method according to any one of aspects 7 to 10, wherein the second food product component is solid, liquid or gaseous after the solidification and/or stabilization.
12. The method according to any one of the preceding aspects, wherein the first and second food product components are present in different phases after the solidification and/or stabilization.
13. The method according to any one of the preceding aspects, wherein the solidification and/or stabilization comprises heating and/or cooling the food product components.
14. The method according to aspect 13, wherein the solidification and/or stabilization comprises heating the food product components by at least 5 K, preferably by at least 15 K and most preferably by at least 30 K.
15. The method according to aspect 13 or 14, wherein the solidification and/or stabilization comprises heating the food product components to at least 30° C., preferably to at least 35° C. and most preferably to at least 40° C.
16. The method according to aspect 13, 14 or 15, wherein the solidification and/or stabilization comprises cooling the food product components by at least 5 K, preferably by at least 10 K and most preferably by at least 15 K.
17. The method according to aspect 13, 14, 15 or 16, wherein the solidification and/or stabilization comprises cooling the food product components to at most 80° C., preferably to at most 70° C., most preferably to at most 60° C.
18. The method according to any one of the preceding aspects, wherein the solidification and/or stabilization is at least partially due to shear-liquefaction of at least one of the food product components and subsequent solidification.
19. The method according to aspect 18, wherein at least one of the food product components comprises a texturing agent such as, for example, xanthan gum.
20. The method according to any one of the preceding aspects, wherein the solidification and/or stabilization is at least partially due to a change in the pH value of at least one of the food product components.
21. The method according to aspect 20, wherein at least one of the food product components comprises microorganisms and/or acidifiers such as, e.g., glucono-delta-lactone.
22. The method according to any one of the preceding aspects, wherein the solidification and/or stabilization is at least partially due to crosslinking of proteins in at least one of the food product components.
23. The method according to aspect 22, wherein at least one of the food product components comprises enzymes such as, e.g., transglutaminase.
24. The method according to any one of the preceding aspects, wherein the first and/or second food product component, preferably only the first food product component, comprises one or a combination of the following materials: gelling agents, thickening agents, dietary fibers, emulsifying agents, foam stabilizers such as carrageenan, agar, alginate, gelatin, cellulose and cellulose derivatives, starch and starch derivatives, guar gum, locust bean gum, gellan gum, konjac, lecithin, mono- or diglycerides, sugar esters of fatty acids, citric acid esters and lactic acid esters of fatty acids.
25. The method according to any one of the preceding aspects, wherein the first and/or second food product component, preferably only the second food product component, comprises one or a combination of the following materials: water, oil, nutrients, proteins, mineral nutrients, vitamins, dietary fibers, microorganisms, enzymes, texturing agents, colorants, flavoring substances, taste-producing substances such as, e.g., salt or sugar, flavor enhancers.
26. The method according to any one of the preceding aspects, wherein the unoccupied volume elements are occupied by food product components in layers.
27. A device for carrying out the method according to any one of the preceding aspects, wherein the device comprises:
   at least one first receptacle containing the first food product component,
   at least one second receptacle containing the second food product component,
   at least one first metering outlet for dispensing the first food product component and introducing the first food product component into a plurality of first unoccupied volume elements of the food product to be structured,
   at least one second metering outlet for dispensing the second food product component and introducing the second food product component into a plurality of second unoccupied volume elements of the food product to be structured,
   a positioning device adapted to position the first and/or the second metering outlet or metering outlets along at least two degrees of freedom, and
   a control device adapted to control the positioning device as well as the operation of dispensing the first and second food product components from the first and the second metering outlet or metering outlets.
28. The device according to aspect 27, wherein the positioning device is further adapted to position the first and second metering outlets along a third degree of freedom.
29. The device according to aspect 27 or 28, wherein the first receptacle and the first metering outlet are formed by a first metering container which comprises the first metering outlet, and wherein the second receptacle and the second metering outlet are formed by a second metering container which comprises the second metering outlet.
30. The device according to any one of aspects 27 to 29, wherein the device further comprises first and second metering devices adapted to dispense the first and second food product components in controlled volumes from the first and second metering outlets.
31. The device according to aspect 30, wherein the first and/or second metering device is adapted to dispense a volume of smaller than 30 mm³, preferably smaller than 20 mm³, more preferably smaller than 10 mm³ and most preferably smaller than 5 mm³ from the first and/or second metering outlet.
32. The device according to any one of aspects 27 to 31, wherein the device further comprises a heating and/or cooling device.
33. A microstructured food product that consists at a plurality of first volume elements of a first food product component, that consists at a plurality of second volume elements of a second food product component and that optionally consists at a plurality of further volume elements of one or more further food product components, wherein the second food product component differs from the first food product component, wherein the one or more further food product components differ from the first and second food product components, wherein the first and second volume elements are disjunctive and wherein at least part of the second volume elements are completely surrounded by the first and/or one or more further food product components.
34. The microstructured food product according to aspect 33, wherein at least 50%, preferably at least 90% of the second volume elements are completely surrounded by the first and/or one or more further food product components.
35. The microstructured food product according to aspect 33 or 34, wherein at least part of the first volume elements, preferably at least 50%, more preferably at least 90%, are completely surrounded by the second and/or one or more further food product components.
36. The microstructured food product according to any one of aspects 33 to 35, wherein at least part of the second volume elements, preferably at least 50%, more preferably at least 90%, are smaller than 30 mm³, preferably smaller than 20 mm³, more preferably smaller than 10 mm³ and most preferably smaller than 5 mm³.
37. The microstructured food product according to any one of aspects 33 to 36, wherein the first and/or the second food product component is liquid, gaseous, gel-like, pasty or solid.
38. The microstructured food product according to any one of aspects 33 to 37, wherein the first food product component comprises a binder.
39. The microstructured food product according to any one of aspects 33 to 38, wherein the second food product component comprises no binder.
40. The microstructured food product according to any one of aspects 33 to 39, wherein the first food product component is gel-like, pasty or solid and the second food product component is solid, liquid or gaseous.
41. The microstructured food product according to any one of aspects 33 to 40, wherein the first and second food product components are present in different phases.
42. The microstructured food product according to any one of aspects 33 to 41, wherein the first and/or second food product component, preferably only the first food product component, comprises one or a combination of the following materials: gelling agents, thickening agents, dietary fibers, emulsifying agents, foam stabilizers such as carrageenan, agar, alginate, gelatin, cellulose and cellulose derivatives, starch and starch derivatives, guar gum, locust bean gum, gellan gum, konjac, lecithin, mono- or diglycerides, sugar esters of fatty acids, citric acid esters and lactic acid esters of fatty acids.
43. The microstructured food product according to any one of aspects 33 to 42, wherein the first and/or second food product component, preferably only the second food product component, comprises one or a combination of the following materials: water, oil, nutrients, proteins, mineral nutrients, vitamins, dietary fibers, microorganisms, enzymes, texturing agents, colorants, flavoring substances, taste-producing substances such as, e.g., salt or sugar, flavor enhancers.
44. The method according to any one of aspects 1 to 26, further comprising introducing a third food product component into a plurality of third unoccupied volume elements of the food product to be structured, wherein the third food product component preferably differs from the first and/or second food product component and/or wherein preferably the first, second and third volume elements are disjunctive.
45. The method according to aspect 44, wherein the step of solidifying and/or stabilizing one or more of the food product components comprises solidifying and/or stabilizing at least part of the third volume elements occupied by the third food product component.
46. The method according to aspect 44 or 45, wherein the first and/or second food product component is liquid and/or gaseous in at least part of the first and/or second volume elements after the solidification and/or stabilization.
47. The method according to aspect 45 or 46, wherein the third volume elements constitute an edge portion or the surface of the food product.
48. The method according to aspect 45, 46 or 47, wherein the third volume elements form stabilizing areas and/or a netlike structure.
49. The method according to any one of aspects 45 to 48, wherein sectors with first and second volume elements are surrounded by third volume elements.
50. The microstructured food product according to any one of aspects 33 to 43, wherein the food product consists at a plurality of third volume elements of a third food product component, wherein the third food product component preferably differs from the first and/or second food product component and/or wherein the first, second and third volume elements are preferably disjunctive.
51. The microstructured food product according to aspect 50, wherein at least part of the third volume elements occupied by the third food product component are solidified and/or stabilized.
52. The microstructured food product according to aspect 50 or 51, wherein the first and/or second food product component is liquid and/or gaseous in at least part of the first and/or second volume elements.
53. The microstructured food product according to aspect 51 or 52, wherein the third volume elements constitute an edge portion or the surface of the food product.
54. The microstructured food product according to aspect 51, 52 or 53, wherein the third volume elements form stabilizing areas and/or a netlike structure.
55. The microstructured food product component according to any one of aspects 51 to 54, wherein sectors with first and second volume elements are surrounded by third volume elements.

In the following, preferred embodiments of the invention are described in more detail with reference to the Figures, in which:

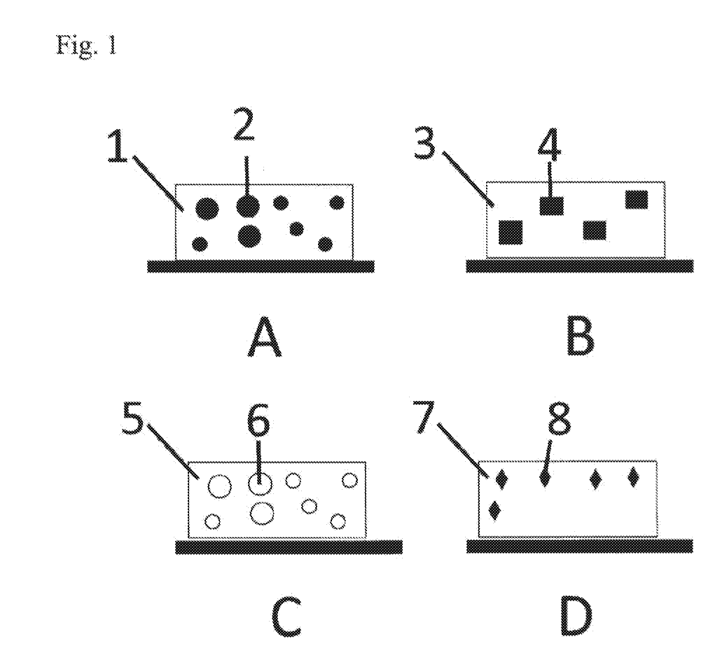

FIGS. 1A-D schematically show microstructured food products according to preferred embodiments of the present invention;

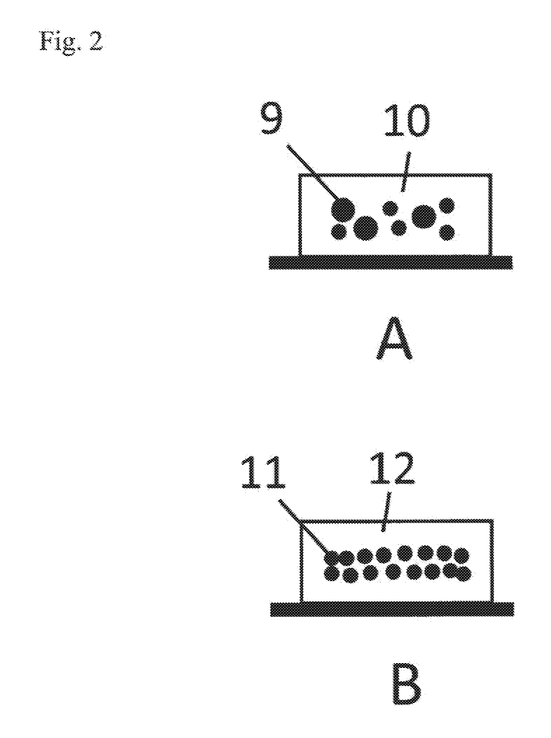

FIGS. 2A-B schematically show microstructured food products according to preferred embodiments of the present invention;

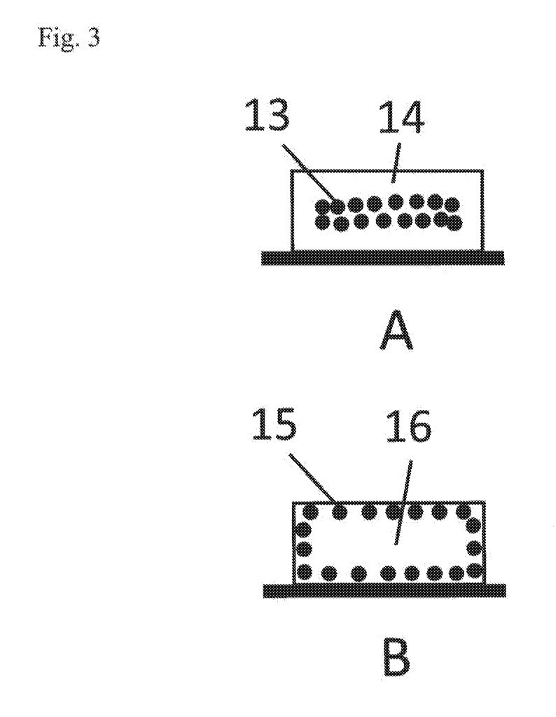

FIGS. 3A-B schematically show microstructured food products according to preferred embodiments of the present invention;

FIG. 4 schematically shows a method for three-dimensionally structuring a food product according to a preferred embodiment of the present invention;

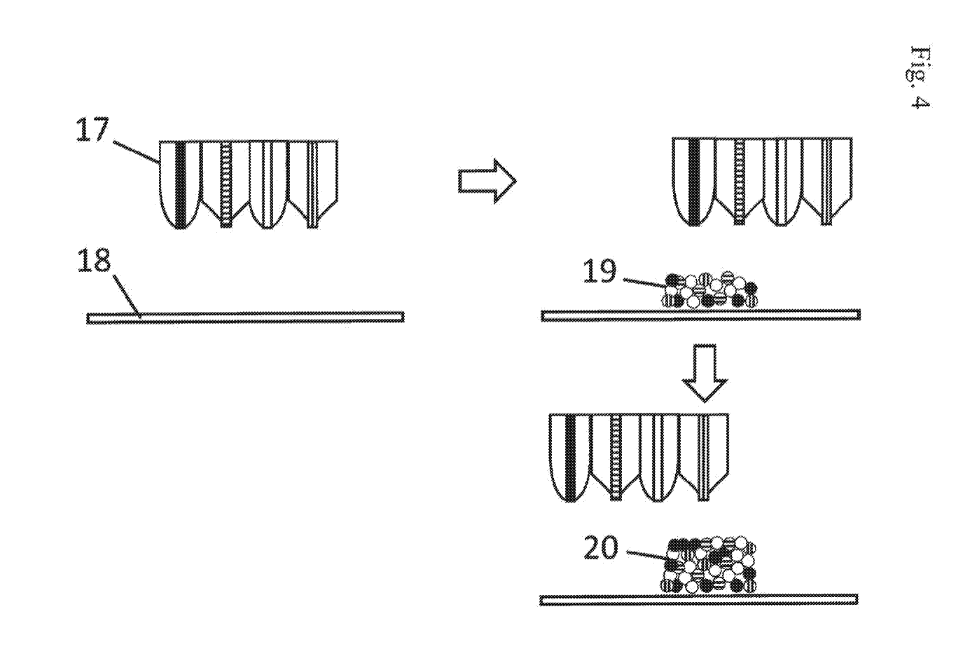

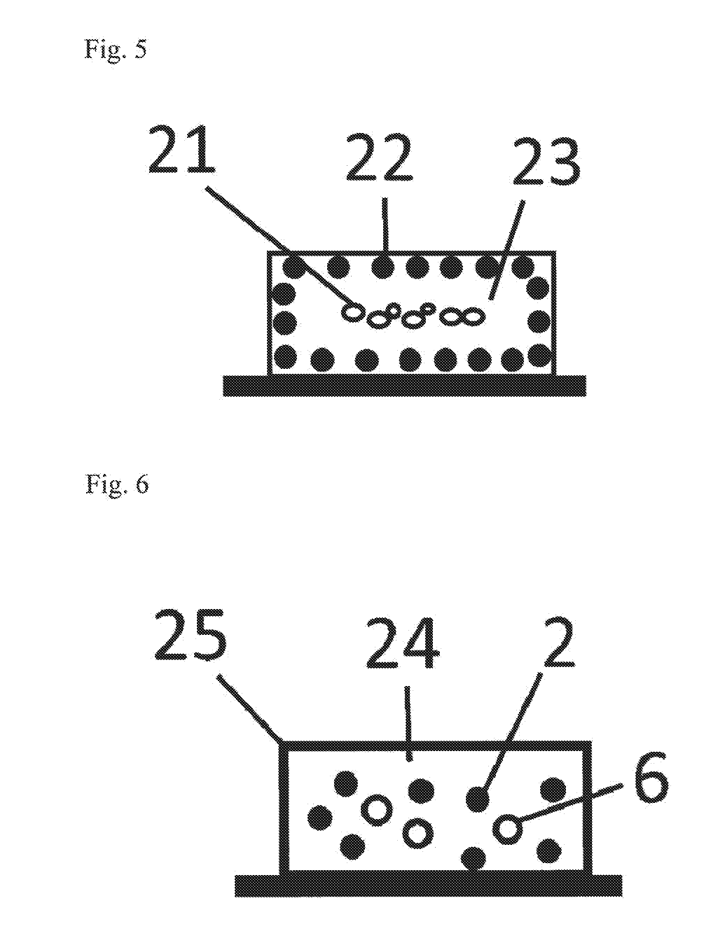

FIG. 5 schematically shows a microstructured food product according to a preferred embodiment of the present invention;

FIG. 6 schematically shows a microstructured food product according to a preferred embodiment of the present invention;

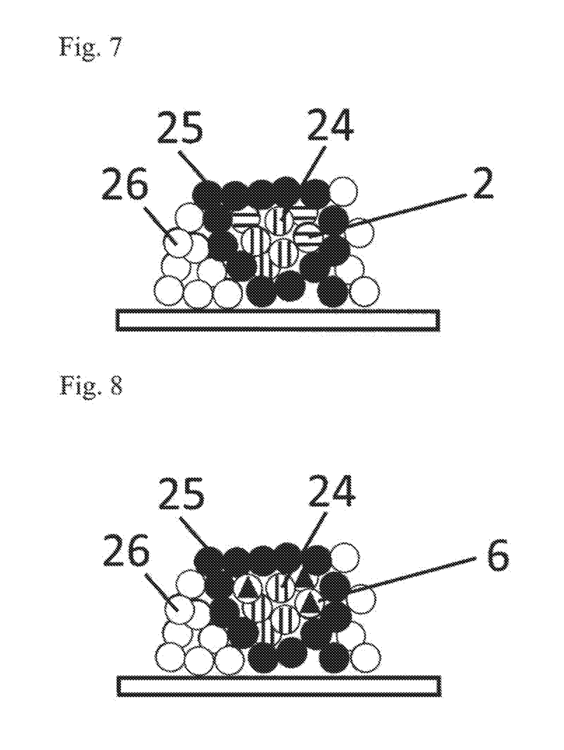

FIG. 7 schematically shows a microstructured food product according to a preferred embodiment of the present invention; and

FIG. 8 schematically shows a microstructured food product according to a preferred embodiment of the present invention.

FIG. 1 shows a schematic sectional view of different microstructured food products according to preferred embodiments of the present invention. The microstructured food product consists at a plurality of first volume elements of a first food product component 1, 3, 5, 7 (which here form a cohesive volume), and consists at a plurality of second volume elements of a second food product component 2, 4, 6, 8, wherein the second food product component 2, 4, 6, 8 differs from the first food product component 1, 3, 5, 7. The first and second volume elements are disjunctive and at least part of the second volume elements are completely surrounded by the first food product component (wherein in FIG. 1 all second volume elements are completely surrounded by the first food product component).

In FIGS. 1A-D, different second food product components are depicted as different symbols. According to the invention, for example, liquid voxels 2 of, for example, oil or water can be in a solidified food product component 1. Such liquid food product components typically form drops during structuring the food product, e.g., in the form of spheres, as illustrated in FIG. 1A. FIG. 1B shows an example in which voxels of a non-solidifying food product component 4 have been introduced into a solidified food product component 3. These voxels can assume any shape. In particular, the interfacial tension is irrelevant here so that the voxels should not assume an approximately spherical shape by themselves. Alternatively or additionally, voxels of a gaseous food product component 6 can be in a solidified food product component 5, cf. FIG. 1C. In FIG. 1D, voxels of a crystal-shaped food product component 8 are illustrated in a solidified food product component 7. The shape of these voxels can likewise be arbitrary but is defined, i.a., by the crystal structure.

The present invention, of course, is not restricted to the two-component system illustrated in FIG. 1. In fact, further food product components can be provided in addition to the first and second food product components. It is also possible that liquid, gaseous, non-solidified, solidified and/or crystal-shaped and/or powdery food product components can be used in one and the same food product. The voxels of one food product component may have approximately the same shape and size (cf. FIG. 1D) or may vary in shape and/or size, as can be seen, for example, in FIGS. 1A and C.

The distribution of the different food product components can be substantially homogeneous within the food product. However, it is also possible that one or more food product components are selectively arranged in specific sectors of the structured food product only. FIG. 2, for example, shows a microstructured food product according to a preferred embodiment of the present invention according to which a second food product component 9, 11 is only in a core region in the center of the food product 10, 12 so that the edges of the food product are essentially free from the second food product component. For example, heat-sensitive or oxygen-sensitive ingredients such as, e.g., health-promoting microorganisms or vitamins or secondary plant ingredients such as, e.g., polyphenols, phytosterols or flavanols can be placed in the center of the food product and thus better protected against the destructive effect of heat or oxygen. The size of the voxels of the second food product component 9, 11 can vary, cf. FIG. 2A, or essentially be constant, cf. FIG. 2B.

A situation analogous to that of FIG. 2B is illustrated in FIG. 3A. Alternatively, the second food product component 15 can also be exclusively provided in the edge portion of the food product 16, as illustrated in FIG. 3B. Thus, it is possible, for example, to incorporate specific food product components, such as, e.g., salt or sugar, which should be contained in as small doses as possible for health considerations, into the food product exclusively or to a great extent near the surface. Since many food products are often not completely chewed, the taste sensation is primarily dominated by ingredients arranged in the vicinity of the surface.

According to the invention, the effects described here can also be combined with each other. FIG. 5, for example, schematically illustrates a microstructured food product according to a further preferred embodiment of the present invention in which voxels of two different food product components 21 and 22 are in a solidified food product component 23, wherein voxels of the food product component 22 (e.g., salt or sugar) which have the same size are at or in the vicinity of the surface of the food product and the same time voxels of a food product component 21 (e.g., vitamins) which have different sizes are in the center of the food product.

FIG. 4 schematically illustrates a method for three-dimensionally structuring a food product according to a preferred embodiment of the present invention. In this method, different (here: four) food product components are respectively introduced into a plurality of unoccupied volume elements of the food product to be structured, wherein the respective volume elements are disjunctive from each other. This can be achieved, for example, by means of a multi-component printhead 17 which prints the food product components onto a stationary surface or substrate 18. A solidified food product structure 19, 20 of different components is thereby formed bit by bit. To this end, one or more of the food product components are solidified or stabilized, which may take place automatically or may require an additional stabilization step. FIG. 6 exemplarily shows a schematic sectional view of a microstructured food product according to the method of the present invention in which the three-dimensional structure is guaranteed by a solidified outer shell 25 while liquid food product components 2, 24 and/or gaseous food product components 6 which do not decisively have to contribute to maintain the three-dimensional structure may be arranged inside this structure. Thus, due to the microstructural oil elements 2 or microstructural gaseous elements 6, it is also possible that there are defined emulsion-like (oil/liquid) or foam-like (gas/liquid) microstructures or mixtures thereof in the food product. In other words, solidified and/or stabilized voxels can surround not only individual liquid or gaseous voxels but also sectors of a plurality of different voxels which are liquid or gaseous or represent combinations of both phases. In these sectors, also voxel structures may form which contain different liquid components that are not dissolvable in each other such as, e.g., hydrophobic food product components such as oils, flavoring substances, vitamins and hydrophilic aqueous solutions of different water-soluble food product components such as proteins, sugars or salts. The product that forms in such a sector may be an emulsion.

Furthermore, voxel structures that contain liquid and gaseous components may also form in these sectors. The product that forms in such sectors may be a foam.

Additionally, voxel structures of liquids and solids can also form in these sectors. The product that forms in such sectors could be a suspension or dispersion. The liquid sectors within these solidified voxels can be partially or completely solidified during a possible post-treatment step (such as, e.g., heating).

Preferably, the stabilizing shell 25 completely surrounds the food product so that the entire surface of the food product is formed by the shell 25, i.e., the stabilized volume elements. However, the stabilized volume elements can also form only part of the food product surface. For example, a stabilizing layer can be possibly renounced at the supporting area of the food product since it is ensured by the substrate. Alternatively, the stabilizing skin or shell 25 may be, for example, cup-shaped so that the upper surface of the food product is formed by liquid and/or gaseous volume elements 2, 6, 24.

Alternatively or in addition to a stabilizing skin or shell as schematically illustrated in FIG. 6, the third (i.e., solidified) volume elements can also stabilize the food product inside in that, for example, a netlike or honeycomb-like structure is formed. The third volume elements can form stabilizing areas inside the food product which preferably completely surround individual sectors of the food product. This is schematically illustrated in FIGS. 7 and 8 each of which show a section of a food product according to the invention. In FIG. 7, sectors (one of these sectors being depicted) comprising an emulsion of a first liquid food product component 2 (for example, a hydrophobic component such as, e.g., oil) and a second liquid food product component 24 (for example, an aqueous component) are each surrounded or enclosed by a shell or skin of the third, stabilized food product component 25. Analogously, for example, sectors comprising a foam of a first gaseous food product component 6 (for example, air) and a second liquid food product component 24 (for example, an aqueous component) can each be surrounded or enclosed by a shell or skin of the third, stabilized food product component 25, as shown in FIG. 8 (wherein, again, only one of these sectors is depicted). The volume elements 26 may either contain the same liquid or gaseous food product components as those contained within the sector surrounded by the shell 25 or any further food product components.

However, it is preferred that the stabilizing shells 25 extend in a netlike or honeycomb-like way through the entire food product in order to ensure an essentially homogenous stability. These honeycombs may be present in an unshaped and unordered way, as indicated in FIGS. 7 and 8. However, ordered, geometric supporting structures are also conceivable. The third volume elements may form, for example, vertical and horizontal stabilizing walls which intersect in a netlike way. However, it is generally preferred that sectors containing both first and second volume elements are surrounded by third volume elements, as can be seen in FIGS. 7 and 8.

In the following, the invention will be described in more detail by means of some examples, which are not to be understood to be limiting in any way:

### EXAMPLE 1: PRODUCTION OF A MICROSTRUCTURED OIL-ENRICHED PEA PUREE

### (A) Production of Food Product Component 1:

350 g of young, extra fine peas are cooked (blanched) in 2 L of briskly boiling salt water for 5 min
The water is poured off and (optionally in order to maintain the color) the peas are cooled with ice water
The peas are mashed in a Blixer® for 8 min
In the meantime, 92.4 g of tap water (° dH>7) is put in a pot
2.4 g of carrageenan, 4 g of methyl cellulose and 1.2 g of xanthan gum are weighed, mixed and dispersed in the 92.4 g of water
300 g of the pea puree is added to the 100 g of texturing agent suspension and stirred in with a whisk

### (B) Food Product Component 2: Rapeseed Oil

### Microstructured Food Product Printing

The pea puree blended with xanthan gum and the oil are filled in two separate receptacles/cartridges each comprising a metering outlet and these receptacles/cartridges are inserted in the multiple printhead. The operation of metering the food product matrices out of this printhead can be controlled separately for each cartridge. The pea puree heated to 60° C. is then metered from cartridge 2 via a metering tip having a diameter of 0.2 mm in a first coherent layer as a circle or disk having a diameter of 5 cm onto a plate used as printing substrate. Subsequently, a second layer of pea puree is applied in the same way. The height of an individual layer of pea puree is 0.5 mm.

As the second step, oil drops having a volume of 0.1 μl (at most 0.4 μl) are metered onto the gelled layer of pea puree at a distance of 2.5 mm from each other, wherein a circle edge of 4 mm is left unoccupied by oil drops.

In the third production step, a third layer of pea puree is applied over the oil drops in a circular or disk-like way so that the oil drops are incorporated into the pea puree in a way having a defined microstructure and each oil drop is surrounded by pea puree. Further production steps are performed accordingly so that finally a cylinder of gelled pea puree having a height of 2 cm is formed.

### EXAMPLE 2: PRODUCTION OF A MICROSTRUCTURED PEA PUREE EXHIBITING INCREASED FLAVOR RELEASE

### (A) Production of Food Product Component 1 According to Example 1

### (B) Food Product Component 2: 0.4 ml of Pea Flavor

### Microstructured Food Product Printing

Analogous to Example 1 with flavor drops instead of oil drops.

### EXAMPLE 3: PRODUCTION OF A MICROSTRUCTURED PEA PUREE HAVING A SELECTED DISTRIBUTION OF Salt

(A) Production of food product component 1 according to Example 1
(B) Food product component 2: crystalline, fine-grained common salt

### Microstructured Food Product Printing

Analogous to Example 1, wherein, as the second step, individual crystalline, fine-grained salt crystals are metered from cartridge 1 in the shape of a circle having a distance of 2.3 cm from the center of the circle and at a distance of 1 mm from each other onto the gelled layer of pea puree.

In the third production step, a third layer of pea puree is circularly applied over the salt crystals so that the salt crystals are incorporated into the pea puree in a way having a defined microstructure and each salt grain is surrounded by pea puree. In the course of the further microstructured printing operation of the pea puree, the concentrated, crystalline salt is metered into the resulting pea puree cylinder at a distance from the surface of 2 mm. The resulting distribution of the crystalline salt close to the surface in the gelled pea puree (cf. FIG. 3B) leads to the perception of a salty taste of the entire object while in total the salt concentration of the product is low.

### EXAMPLE 4: PRODUCTION OF MICROSTRUCTURED PASTRY HAVING DEFINED PORES

### Food Product Component

25 g of rapeseed oil is whisked with 16 g of sugar, 22 g of egg and 0.5 g of salt.

80 g of gluten-free cornmeal is mixed with 10 g of wheat flour.

The mixture of cornmeal and wheat flour as well as 30 g of water are alternately added to the mixture of oil, sugar, egg and salt.

The ingredients are kneaded into a homogenous dough.

The dough must rest for 30 minutes.

### Production of Microstructured Pores

The pastry is microstructured in that the dough is applied onto the printing substrate in a spatially exactly defined way.

To this end, strands having a diameter of 0.3 mm are applied by means of a printhead from a nozzle having a diameter of 0.5 mm onto the printing substrate in a spatially comprehensive first layer having dimensions of 4 cm×5 cm. The second printing layer is applied as a grid structure having square openings with an edge length of 1 mm. The subsequent printing layer is again applied as a coherent layer. The resulting openings in the grid lead in the printed object to cubical cavities having an edge length of 1 mm and being completely surrounded by the food product component. In this Example, the second food product component is formed by air (pores).

### EXAMPLE 5: PRODUCTION OF A MICROSTRUCTURED FRUIT JELLY EXHIBITING INCREASED FLAVOR RELEASE

### (A) Production of Food Product Component 1:

90 g of mango juice is blended with 0.9 g of carrageenan, 0.54 g of xanthan gum and 2 g of water
The mixture is stirred and the carrageenan and xanthan gum are dissolved
The mixture is brought to a boil and boiled down to 90 g
The mixture is tempered in a bain-marie to 60° C.

### (B) Food Product Component 2: 0.1 ml Mango Flavor

### Microstructured Food Product Printing

The juice mixture blended with xanthan gum and carrageenan and the mango flavor are filled in two separate receptacles/cartridges each comprising a metering outlet and these receptacles/cartridges are inserted in the multiple printhead. The operation of metering the food product matrices out of this printhead can be controlled separately for each cartridge. The mango printing mass preheated to 60° C. is tempered to 40° C. in cartridge 2 and then metered from cartridge 2 via a metering tip having a diameter of 0.2 mm in a first coherent layer as a circle or disk having a diameter of 5 cm onto a plate used as printing substrate. Subsequently, a second layer of mango printing mass is applied in the same way. The height of an individual layer of mango printing mass is 0.5 mm.

As the second step, flavor drops having a volume of 0.01 μl (at most 0.04 μl) are metered onto the gelled mango printing mass at a distance of 2.5 mm from each other.

In the third production step, a third layer of mango printing mass is applied over the flavor drops in a circular or disk-like manner so that the flavor drops are incorporated into the mango printing mass in a way having a defined microstructure and ultimately each flavor drop is surrounded by gelled mango juice.

Further production steps are performed accordingly so that finally a cylinder of gelled mango juice having a height of 2 cm is formed.

### EXAMPLE 6: PRODUCTION OF A VITAMIN-ENRICHED, MICROSTRUCTURED POTATO PRODUCT COMPRISING THE SELECTED PLACEMENT OF OIL

### (A) Production of Food Product Component 1:

480 g of water is brought to a boil
4 g of salt is added
200 ml of milk and 20 g of butter are added to the hot salt water and stirred in
Then 115 g of potato puree flakes are stirred in
The potato printing mass is allowed to rest for 1 min in order to rise and agitated again
Then the potato printing mass is pressed through a fine sieve
The potato printing mass is cooled down to room temperature

### (B) Food Product Component 2: 10 ml of Rapeseed Oil

### (C) Production of Food Product Component 3:

Rapeseed oil enriched with vitamin D: 5 mg of vitamin D is dissolved in 10 ml of rapeseed oil

### Microstructured Food Product Printing

The potato printing mass, the rapeseed oil and the vitamin D-enriched rapeseed oil are filled in three separate receptacles/cartridges each comprising a metering outlet and these receptacles/cartridges are inserted in the multiple printhead. The operation of metering the food product matrices out of this printhead can be controlled separately for each cartridge. The operation of metering all components can be carried out at room temperature for the potato product. The potato printing mass is then metered from cartridge 1 via a metering tip having a diameter of 0.2 mm in a first coherent layer as a rectangle having an area of 10 cm² onto a plate used as printing substrate. Subsequently, a second layer of potato printing mass is applied in the same way. The height of an individual layer of potato printing mass is 0.5 mm.

As the second step, oil drops having a volume of 0.1 μl (at most 0.4 μl) are metered from cartridge 2 onto the gelled potato puree layer at a distance of 2.5 mm from each other, wherein an edge of 2 mm is left unoccupied by oil drops.

In the third production step, a third layer of potato puree is applied over the oil drops so that the oil drops are incorporated into the potato puree in a way having a defined microstructure and each oil drop is surrounded by potato puree. In further production steps, potato printing mass and oil drops are accordingly applied so that the oil drops are arranged at the outer layer at a distance of 2 mm from the surface.

After 15 layers of potato printing mass, vitamin D-enriched oil drops having a volume of 0.1 μl (at most 0.4 μl) are metered from cartridge 3 at a distance of 2.5 mm from each other into the inner region of the rectangle with a distance of 5 mm from the edge. This is followed by the application of a layer of potato printing mass so that the oil drops are incorporated into the potato puree in a way having a defined microstructure and ultimately each oil drop is surrounded by potato puree. In the subsequent 10 layers, vitamin D-enriched oil drops are metered after every two potato puree layers. Then follow further 15 layers of potato printing mass. Onto this potato puree cuboid, oil drops having a volume of 0.1 μl (at most 0.4 μl) are metered again from cartridge 2 at a distance of 2.5 mm from each other onto the gelled potato puree layer, wherein an edge of 2 mm is left unoccupied by oil drops. Finally, two layers of potato puree are metered onto the cuboid.

Thus, a microstructured potato product in which the vitamins inside are protected against influences of, for example, temperature, light and oxygen is structured. There is an oil-enriched outer layer at the surface of the described product which results in a crispy, crusty crust when the potato product is heated.

1. A method for three-dimensionally structuring a food product comprising the steps of:
(a) introducing a first food product component into a plurality of first unoccupied volume elements of the food product to be structured;
(b) introducing a second food product component into a plurality of second unoccupied volume elements of the food product to be structured, wherein the second food product component differs from the first food product component, wherein the first and second volume elements are disjunctive;
(c) optionally introducing one or more further food product components into a plurality of further unoccupied volume elements of the food product to be structured, wherein the one or more further food product components differ from the first and second food product components; and
(d) solidifying and/or stabilizing one or more of the food product components;
wherein at least part of the second volume elements are completely surrounded by the first and/or one or more further food product components.

2. The method according to claim 1, wherein at least 50% of the second volume elements are completely surrounded by the first and/or one or more further food product components.

3. The method according to claim 1, wherein at least part of the second volume elements are smaller than 30 mm³.

4. The method according to claim 1, wherein the solidification and/or stabilization comprises heating and/or cooling the food product components.

5. The method according to claim 1, wherein the solidification and/or stabilization is at least partially due to shear-liquefaction of at least one of the food product components and subsequent solidification.

6. The method according to claim 1, wherein the solidification and/or stabilization is at least partially due to a change in the pH value of at least one of the food product components.

7. The method according to claim 1, wherein the solidification and/or stabilization is at least partially due to crosslinking of proteins in at least one of the food product components.

8. The method according to claim 1, wherein the unoccupied volume elements are occupied by food product components in layers.

9. The method according to claim 1, further comprising introducing a third food product component into a plurality of third unoccupied volume elements of the food product to be structured, wherein the third food product component differs from the first and/or second food product component and wherein the first, second and third volume elements are disjunctive.

10. (canceled)

11. The method according to claim 9, wherein the first and/or second food product component is liquid and/or gaseous in at least part of the first and/or second volume elements after the solidification and/or stabilization.

12. The method according to claim 11, wherein the third volume elements constitute an edge portion or the surface of the food product.

13. (canceled)

14. The method according to claim 11, wherein sectors with first and second volume elements are surrounded by third volume elements.

15. A device for carrying out the method according to claim 1, wherein the device comprises:
at least one first receptacle containing the first food product component,
at least one second receptacle containing the second food product component,
at least one first metering outlet for dispensing the first food product component and introducing the first food product component into a plurality of first unoccupied volume elements of the food product to be structured,
at least one second metering outlet for dispensing the second food product component and introducing the second food product component into a plurality of second unoccupied volume elements of the food product to be structured,
a positioning device adapted to position the first and second metering outlets along at least two degrees of freedom, and
a control device adapted to control the positioning device as well as the operation of dispensing the first and second food product components from the first and second metering outlets.

16. (canceled)

17. A microstructured food product that consists at a plurality of first volume elements of a first food product component, that consists at a plurality of second volume elements of a second food product component and that optionally consists at a plurality of further volume elements of one or more further food product components, wherein the second food product component differs from the first food product component, wherein the one or more further food product components differ from the first and second food product components, wherein the first and second volume elements are disjunctive and wherein at least part of the second volume elements are completely surrounded by the first and/or one or more further food product components.

18. The microstructured food product according to claim 17, wherein at least part of the first volume elements are completely surrounded by the second and/or one or more further food product components.

19. (canceled)

20. The microstructured food product according to claim 17, wherein the first food product component comprises a binder and wherein the second food product component comprises no binder.

21. The microstructured food product according to claim 17, wherein the food product consists of a third food product component at a plurality of third volume elements, wherein the third food product component differs from the first and second food product component and/or wherein the first, second and third volume elements are disjunctive.

22. The microstructured food product according to claim 21, wherein at least part of the third volume elements occupied by the third food product component are solidified and/or stabilized.

23. (canceled)

24. The microstructured food product according to claim 22, Wherein the third volume elements constitute an edge portion or the surface of the food product.

25. (canceled)

26. The microstructured food product according to claim 22, wherein sectors with first and second volume elements are surrounded by third volume elements.
